(19) United States
(12) Patent Application Publication
(10) Pub. No.: US 2014/0104395 A1
(43) Pub. Date: Apr. 17, 2014

(54) Methods of and Systems for Three-Dimensional Digital Impression and Visualization of Objects Through an Elastomer

(71) Applicant: GELSIGHT, INC., Waltham, MA (US)

(72) Inventors: Janos ROHALY, Concord, MA (US); Micah K. JOHNSON, West Roxbury, MA (US); Edward H. ADELSON, Winchester, MA (US)

(73) Assignee: GELSIGHT, INC., Waltham, MA (US)

(21) Appl. No.: 14/056,817

(22) Filed: Oct. 17, 2013

Related U.S. Application Data
(60) Provisional application No. 61/714,762, filed on Oct. 17, 2012.

(51) Int. Cl. H04N 13/02

(52) U.S. Cl. CPC H04N 13/0203
USPC 348/47

(57) ABSTRACT

Methods of and systems for three-dimensional digital impression and visualization of objects through an elastomer are disclosed. A method of estimating optical correction parameters for an imaging system include pressing an object of known surface topography against an elastomer and imaging a plurality of views of the surface topography of the object through the elastomer. The method also includes estimating a three-dimensional model of the object based on the plurality of views and estimating optical correction parameters based on a known surface topography of the object and the estimated three-dimensional model. The optical correction parameters correct distortions in the estimated three-dimensional model to better match the known surface topography.

### CROSS-REFERENCE TO RELATED APPLICATIONS

This application claims priority under 35 U.S.C. §119(e) to U.S. Provisional Application No. 61/714,762, filed Oct. 17, 2012, entitled Three-Dimensional Digital Impression and Visualization of Objects Through a Clear Elastomer, the contents of which are incorporated by reference herein.

### BACKGROUND OF THE INVENTION

1. Field of the Invention

The present invention generally relates to taking and visualizing digital impressions of rigid or deformable objects through a clear elastomer that conforms to the shape of the measured object.

2. Description of Related Art

U.S. Pat. No. 8,411,140, entitled Tactile Sensor Using Elastomeric Imaging, filed on Jun. 19, 2009, and issued Apr. 2, 2013, (incorporated by reference herein) discloses a tactile sensor that includes a photosensing structure, a volume of elastomer capable of transmitting an image, and a reflective membrane (called a “skin” in the patent) covering the volume of elastomer. The reflective membrane is illuminated through the volume of elastomer by one or more light sources, and has particles that reflect light incident on the reflective membrane from within the volume of elastomer. The reflective membrane is geometrically altered in response to pressure applied by an entity touching the reflective membrane, the geometrical alteration causing localized changes in the surface normal of the membrane and associated localized changes in the amount of light reflected from the reflective membrane in the direction of the photosensing structure. The photosensing structure receives a portion of the reflected light in the form of an image, the image indicating one or more features of the entity producing the pressure.

### BRIEF SUMMARY OF THE INVENTION

This application provides methods of and systems for three-dimensional digital impression and visualization of objects through an elastomer.

Under one aspect of the invention, a method of estimating optical correction parameters for an imaging system includes providing an optical sensor system having an image capturing system, an illumination source, and a substantially optically clear elastomer. The elastomer has a first surface facing the image capturing system and a second surface facing away from the image capturing system. The image capturing system has a plurality of views of the second surface through the elastomer. The method also includes pressing an object of known surface topography against the second surface of the elastomer so that features of the surface topography are disposed relative to the second surface of the elastomer by predetermined distances and imaging a plurality of views of the surface topography of the object through the elastomer with the image capturing system. The method further includes estimating a three-dimensional model of at least a portion of the object based on the plurality of views of the surface topography of the object and estimating optical correction parameters based on the known surface topography of the object and the estimated three-dimensional model. The optical correction parameters correct distortions in the estimated three-dimensional model to better match the estimated three-dimensional model to the known surface topography.

Under another aspect of the invention, estimating the optical parameters includes mapping distorted measurements of three-dimensional features estimated from the plurality of views to known measurements of three-dimensional features from the known surface topography.

Under a further aspect of the invention, the methods also include establishing a reference feature using a target image positioned a known distance from the image capturing system and using the reference feature to determine the predetermined distances.

Under still another aspect of the invention, a method of visualizing at least one of a surface shape and a surface topography of an object includes providing an optical sensor system having an image capturing system, an illumination source, and a substantially optically clear elastomer, wherein. The elastomer has a first surface facing the image capturing system and a second surface facing away from the image capturing system. The image capturing system has a plurality of views of the second surface through the elastomer. The method also includes providing an alignment object on the second surface of the elastomer that has surface features and imaging a plurality of views of the surface features of the alignment object through the elastomer with the image capturing system. The method also includes estimating a set of transform parameters that align the images of the plurality of views. The method further includes pressing an object to be visualized into the second surface of the elastomer and imaging a plurality of views of at least one of a surface shape and a surface topography of the object to be visualized through the elastomer with the image capturing system. The method also includes applying the estimated set of transform parameters to the images of the plurality of views to create a plurality of transformed images and displaying at least two of the transformed images as a stereo image pair.

Under still a further aspect of the invention, a surface of the alignment object on the second surface of the elastomer is substantially planar when in contact with the second surface and includes an alignment image.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

FIG. 1 shows a multi-view, 3-D imaging system according to an embodiment of the invention.

FIG. 2 shows an edge lit glass plate with light extraction features according to an embodiment of the invention.

FIG. 3 shows a flowchart of a process for aligning two images to a reference image according to an embodiment of the invention.

FIG. 4 shows a flowchart of a process for creating and displaying high quality stereo image pairs at video rate according to an embodiment of the invention.

FIGS. 5A-5D show images of different steps of a preprocessing process to create high quality stereo image pairs to be visualized as anaglyph images according to an embodiment of the invention.

FIGS. 6A and 6B show a setup to calibrate multiple cameras through an unloaded elastomer according to an embodiment of the invention.

FIG. 7 shows a setup to estimate the amount of required correction of distortion artifacts due to varying elastomer thickness according to an embodiment of the invention.

FIG. 8 shows a flowchart of a process for estimating calibration correction parameters according to an embodiment of the invention.

FIG. 9 shows a flowchart of a process for applying calibration correction parameters to images according to an embodiment of the invention.

FIG. 10 shows a three-camera system according to an embodiment of the invention.

FIG. 11 shows applying a clear elastomer on top of a glass plate according to an embodiment of the invention.

### DETAILED DESCRIPTION

In one embodiment of the present invention, a three-dimensional (3-D) imaging system is provided that captures multi-view images of a rigid or deformable object through an elastomer to visualize and quantify the shape and/or the surface topography of an object in two dimensions (2-D) and in three dimensions either under static or under dynamic conditions. In one implementation, the captured images or stream of images are used to stereoscopically visualize and quantitatively measure the micron scale, three-dimensional topography of surfaces (e.g., leather, abrasive, micro-replicated surface, optical film etc.), or to visualize and quantitatively measure the overall shape of large-scale three-dimensional structures (e.g., foot, hand, teeth, implant etc.). In at least one embodiment, a calibration correction procedure is provided to reduce distortion artifacts in the captured images and 3-D data due to the optical effect of changing thickness of the applied elastomer.

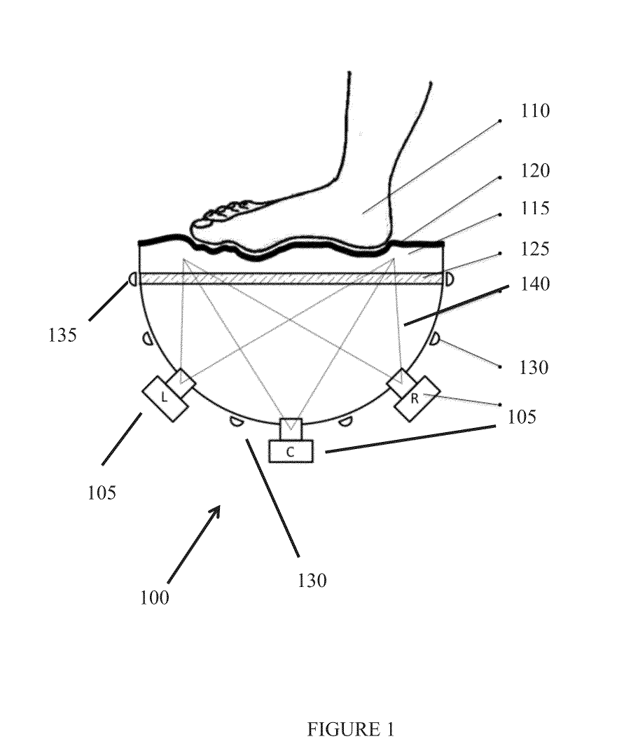

FIG. 1 shows a multi-view, 3-D imaging system 100 according to an embodiment of the invention. System 100 comprises a set of cameras 105 seeing a measured object 110 through a clear elastomer 115 from different directions with fully or partially overlapping views. Although three cameras are shown, more than three, and less than three, are within the scope of the invention. The clear elastomer 115 is thick enough to conform to the static or dynamic shape of the imaged object 110. In some embodiments, the thickness of the elastomer is only few millimeters, and in some other embodiments the thickness of the elastomer is several tens of millimeters, primarily determined by the overall shape of the object being measured. The measured signal produced by the cameras 105 can be the deformation of the texture of the elastomer in contact with the object 110 caused by the applied pressure. However, the deformation of the texture is also described by the changes in the surface normal of the surface of the elastomer.

Optionally, the elastomer can have a reflective surface 120, of varying degrees of reflection directionality, as described in more detail below. However, the reflective surface is not required, as the system 100 can image objects based only on the appearance of the surface of the object 110 in contact with the elastomer 115. For example, if a human foot is being imaged, a sock can be placed on the foot before the foot is pressed into contact with the elastomer 115.

In some implementations, a glass plate 125 is placed in between the elastomer and the cameras. The glass plate 125 enables applying pressure uniformly on the elastomer 115. This pressure enables the system 100 to take an instantaneous impression of the measured object by the elastomer. Due to the applied pressure, the elastomer 115 conforms to the shape of the measured object 110 both at the macro and micro scales. In addition, the glass plate 125 provides support to the elastomer 115 when the object 110 is pressed against the elastomer 115, as shown in FIG. 1. Other materials, such as clear plastics, can be used in place of glass for the glass plate 125.

Illumination of the imaged object 110 may be provided from the camera side of the elastomer 115 by light sources 130 (such as LEDs, for example). In addition to or in substitution of light sources 130, the imaged object can be illuminated through the edge of the glass plate 125 by light sources 135. Both of these options are shown in FIG. 1, but both need not be present. In the case of edge-illumination, the glass plate 125 functions as a light guide to illuminate the object-contact side of the clear elastomer whose refractive index is optionally matched to that of the glass.

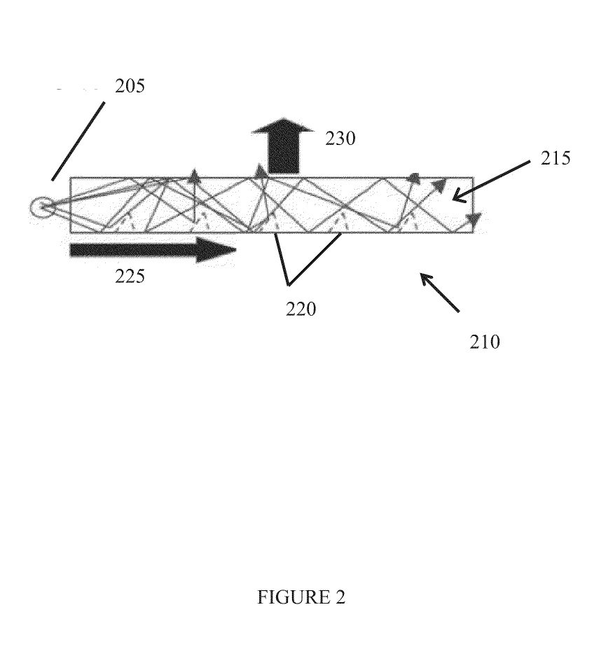

The glass plate may also have light extraction micro features to provide simulated distant illumination, as shown in FIG. 2. In such an embodiment, light sources 205 around the edge of a glass plate 210 illuminate into the glass plate 210, shown by arrow 225. Due to total internal reflection (TIR), light is bounced between the two surfaces of the glass plate (shown by arrows 215) until the light rays reach the elastomer (not shown). In this case TIR is influenced only by the slope of the surface, i.e., the two, parallel sides of the glass plate 210. Optionally, light extracting micro features 220, which are small geometric features on the glass surface with locally different slopes than the sides of the glass plate, provide control on where and how light leaves the glass plate 210, as shown by arrow 230. For example, one can put such light extracting features in a circle around the elastomer, and outside of the view of the cameras, such that when light rays hit these they change direction and illuminate the elastomer as if a light source was placed at the location of the light extracting feature 220. Alternatively, one can arrange many light extracting features 220 such that they simulate distant, collimated illumination. Such light extracting features 220 could be made as part of an optical film bonded to the glass plate 210. Further, the light extracting features 220 can be made smaller than the resolution of the cameras of the system.

Referring again to FIG. 1, when illumination sources 130 are disposed within the hemisphere on the camera side of the clear elastomer, the space between the glass plate 125 and the cameras 105 (space 140) can, optionally, be filled with an index matched medium that could be the same elastomer used for the measurement on the other side of the glass plate 125. Disposing the glass plate 125 between elastomers that are index-matched to that of the glass reduces refraction and/or reflection from the glass surface that can cause imaging problems when the source of illumination is on the camera side of the glass plate 125. Similarly, the space 140 can be filled with a material that has a refractive index matched to the glass plate 125. In the absence of an index-matched material disposed in space 140, the cameras 105 can be disposed relatively closely to the glass plate, so as to reduce negative reflection effects.

The illumination provided by illumination sources 130 can be uniform, sequential, spatially or spectrally multiplexed. The light sources 130 can also implement gradient illumination whether that is defined spatially or spectrally. Illumination can also be linearly or circularly polarized, in which case orthogonal polarization may be used on the imaging path. Illumination may also be understood as creating a pattern or texture on a coated surface of the elastomer that could be used for quantitative 3-D reconstruction of the shape of the object.

For example, when illumination is provided within the hemisphere on the camera side, some of the illumination sources may not be sufficient to illuminate into deep structures, or they may create unwanted shadows. To reduce these unwanted effects, many illumination sources can be implementing to provide different illumination directions. In such an implementation, this solution basically provides light from all possible illumination directions.

Further embodiments include creating a sequential illumination by turning on one or a segment of illumination sources 130 at a time. Spatially multiplexed illumination can be implemented by providing multiple illumination sources with different patterns turned on at the same time. Further still, spectrally multiplexed illumination can be implemented by providing illumination sources with different color turned on at the same time. Certain implementations provide radiant illumination by spatially varying the intensity of the illumination sources within the hemisphere. Alternatively, this can be combined with illumination in different spectral bands (e.g., red, green, and blue channels implementing spatially varying illumination in the different directions, x, y, and z).

Illumination can also be polarized to reduce specularity or sub-surface scattering. Optionally, imaging can be cross-polarized. Patterned or textured illumination can be used to implement structured light projection based 3-D reconstruction.

The clear elastomer 115 can be made from thermoplastic elastomers, polyurethane, silicone rubber, acrylic foam or any other material that is optically clear and can elastically conform to the shape of the measured object. Illustrative examples of suitable materials and designs of the elastomer 115 are found in U.S. Pat. No. 8,411,140. As mentioned above, the clear elastomer facing the imaged object can have, but need not have, an opaque reflective coating. The coating layer facing the cameras may have diffuse Lambertian, or specially engineered reflectance properties. The coating may also be patterned to facilitate registration of the images captured by multiple cameras.

The coating may be a stretchable fabric such as spandex, lycra, or similar in properties to these. The fabric may be dark to minimize secondary reflections, and can have monochrome or colored patterns to facilitate registration between the images. Also, as mentioned above, the object itself can be covered in a fabric, and this fabric covering (e.g., a sock on a foot) can have a textured or patterned surface. The pattern may encode spatial location on the fabric. For example, a matrix barcode (or two-dimensional barcode) may be provided to increase the efficiency of registration. Such an implementation would enable finding corresponding image regions without the time consuming and error prone image registration method (e.g., cross-correlation) as one need only read the encoded position information in the spatial locations encoded in the image.

In this context, “registration” generally means finding corresponding image regions in two or more images. Image registration, or finding correspondences between two images is one of the first steps in multi-view stereo processing. The separation between corresponding or registered image regions determines depth.

Visualization implementations include displaying 2-D images or a 2-D video stream of the object from a pre-selected camera, or displaying a 3-D image or 3-D video stream of the object captured by at least two image paths. A 3-D image or video stream may mean an anaglyph image or anaglyph video stream, or a stereo image or stereo video stream displayed using 3-D display technologies that may or may not require glasses. Other visualization techniques known by those having ordinary skill in the art are within the scope of the invention.

Certain implementations have separate cameras, with each camera having its own lens, to capture multi-view images. Meanwhile, other implementations have a single camera with a lens capable of forming a set of images from different perspectives, such as a lens with a bi-prism, a multi-aperture lens, a lens with pupil sampling or splitting, or a lens capturing the so called integral- or light field image that captures multi-view images. Images through a single lens can be captured on separate or on a single sensor. In the latter case, images may be overlapping, or spatially separated with well-defined boundaries between them.

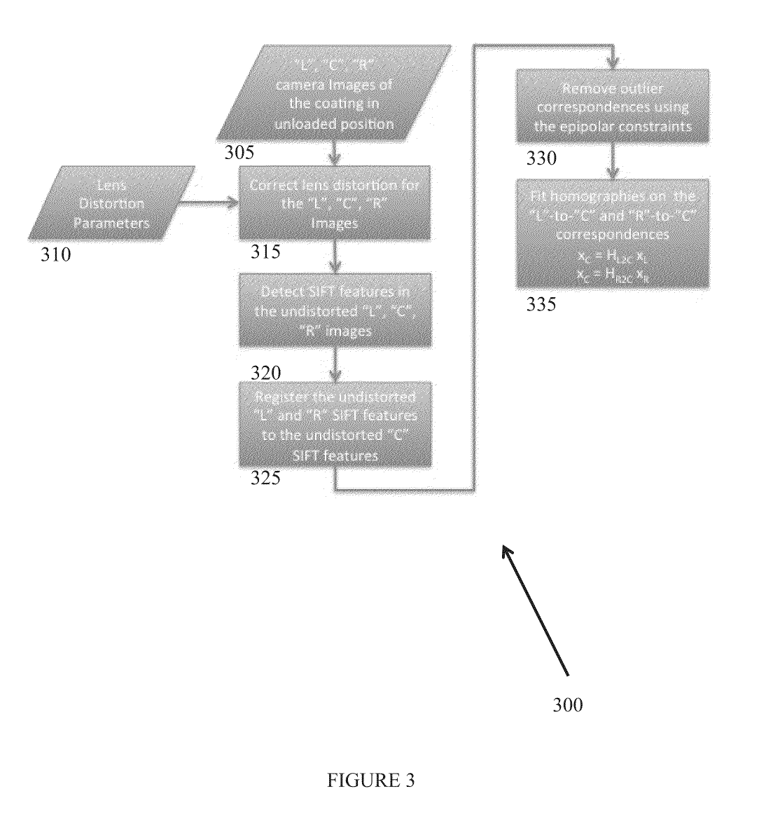

In certain embodiments, the captured images go through multiple pre-processing steps. Such preprocessing can include lens distortion correction, alignment of multiple images onto a reference image to reduce stereo parallax, enforcement of horizontal image disparities, or finding corresponding sub-image regions for three-dimensional reconstruction. FIG. 3 shows a flowchart of a process 300 for aligning two images to a reference image according to an embodiment of the invention. In such an implementation, image alignment between two images is based on a homography. In this context, a homography is a projective transformation describing mapping between planes. Adaptive image contrast enhancement may also be applied to the captured images as part of the image pre-processing step.

One illustrative purpose of the pre-processing steps is to create high quality 3-D stereo image pairs for viewing the instantaneous impressions of the measured object as anaglyph images on any 2-D display (e.g., tablet computer or other display device). Such stereo visualization complements 3-D reconstruction of the shape of the measured object, and allows evaluating static or dynamic shapes of the object on any display for medical or industrial purposes. Alternatively, the created high quality 3-D stereo image pairs can be viewed on a 3-D display.

High quality stereo image pairs can be created from images captured by widely separated cameras even when the cameras have different lenses and sensors. Such cameras may capture an overlapping view with different magnification. In order to create high quality stereo image pairs from such raw images, first, the intrinsic camera and lens distortion parameters (e.g., focal length, skew, and distortion parameters) are determined by calibrating each camera using techniques known in the relevant fields. Next, the camera setup is calibrated in order to determine the relative pose and orientation between cameras. For this purpose, a backlit calibration target (having, e.g., a checkerboard pattern) can be placed behind a clear elastomer without the coating/reflective layer.

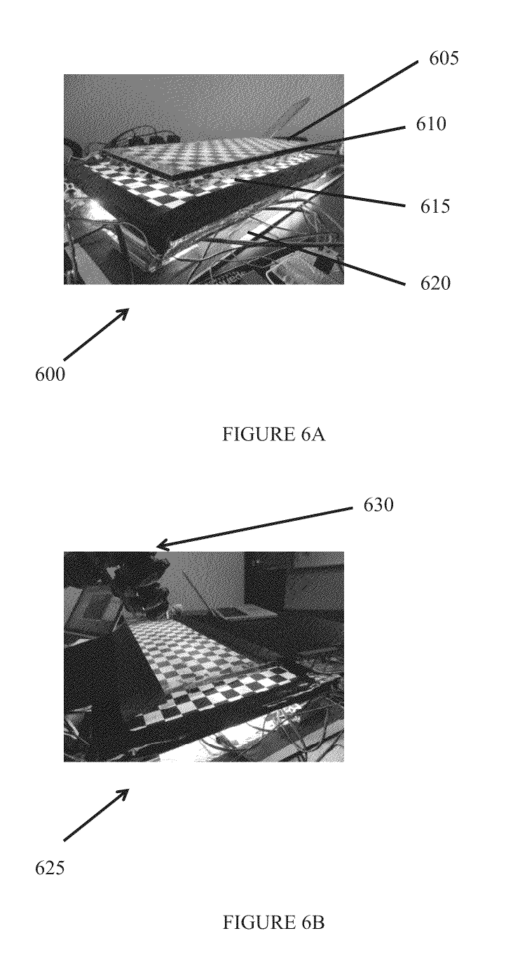

FIGS. 6A and 6B show a setup to calibrate multiple cameras through the unloaded elastomer according to an embodiment of the invention. Calibration setup 600 shows a glass plate 605 on top of an elastomer 610, which rests atop a checkerboard patterned surface 615, of known feature dimension. The patterned surface 615 is backlit using a light box 620. This is collectively called a “checkerboard target” (625) below. During the calibration process, a camera, or multiple cameras rigidly attached to each other 630, are moved, tilted, and/or rotated above the checkerboard target 625 such that the cameras see the checkerboard target through the clear elastomer 610 to obtain left (L), center (C), and right (R) images of the checkerboard pattern through the unloaded elastomer. In this context, “unloaded elastomer” refers to the elastomer without having an object pressed into its surface, i.e., the checkerboard pattern is known to lie in one plane.

This procedure produces a set of lens distortion parameters that can later be used to “undistort” images captured by the camera(s). Distortions could be barrel, pincushion type, and/or other distortions. While the process above describes the checkerboard target 625 as stationary about which the cameras are moved, one of skill in the art will understand that the cameras may remain stationary while the target is moved about the cameras.

As mentioned above, FIG. 3 shows a flowchart of a process 300 for aligning two images to a reference image according to an embodiment of the invention. For process 300, the cameras (or image paths) are set in a fixed position relative to the elastomer in the configuration that will be used during object imaging. First, left, center, and right images of an alignment object are captured by the camera(s) (step 305). The checkerboard target 625 can be used as the alignment object. However, other objects/images can be used and remain within the scope of the invention. Using the lens distortion parameters 310 (provided, e.g., as set forth above), the images captured by the cameras are undistorted (step 315) at the rate with which the cameras capture the images (e.g., video rate). In this context, “undistortion” means removing geometric distortions from the images.

Next, the undistorted images captured by the cameras are aligned on top of each other using a homography that is recovered by registering an image of an overlapping region captured by one of the cameras onto the image of the same region captured by the other camera. To do this, local image features are detected in the undistorted L, C, and R images (step 320) and the undistorted L and R image features are registered to the undistorted C image features (step 325). Feature detection may be done by any of the standard feature detector methods such as SIFT (Scale Invariant Feature Transform) or Harris feature detector. The image registration can be accomplished using techniques known in the art. Next, the outlier correspondences are removed using epipolar constraints (step 330) and the homographies are fit onto the L-to-C correspondence and R-to-C correspondence (step 335).

Because the homography is recovered when no object is pressed against the elastomer, the two images of the frontal surface of the elastomer (the surface facing away from the camera(s)) are brought into alignment. When an object is pressed against the elastomer, the images aligned by the previously recovered homography show the effect of stereo parallax, thereby creating a stereo disparity field between the images according to the shape of the object. This preprocessing step can, optionally, include a stereo rectification step by applying different homographies to the images such that the created image disparities are oriented primarily in the horizontal direction, thereby correcting for vertical mis-alignment between cameras.

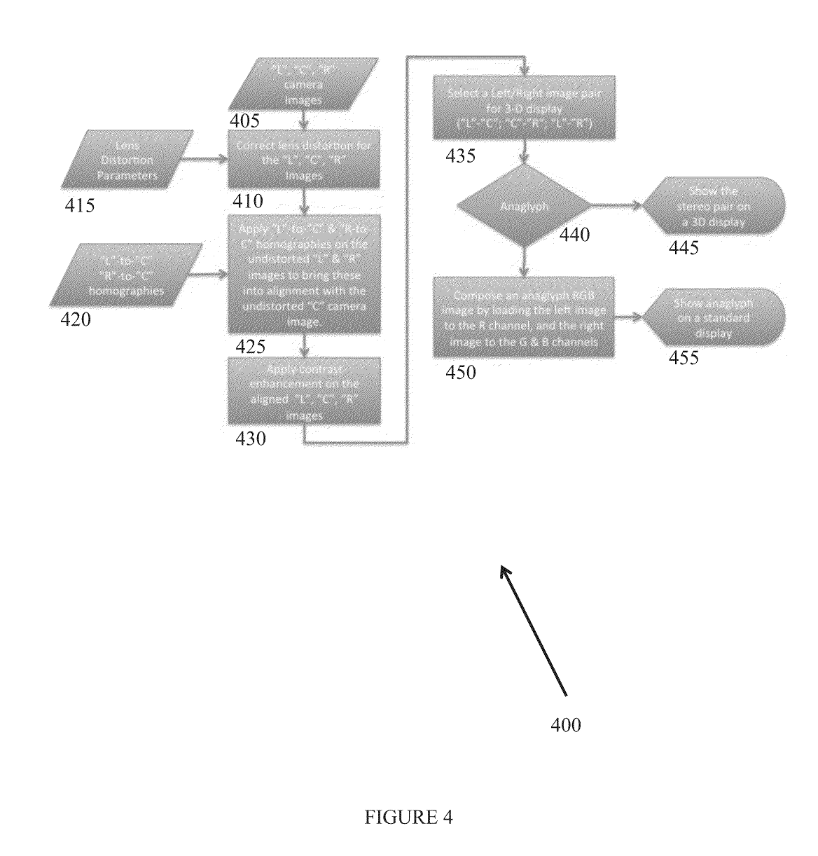

FIG. 4 shows a flowchart of a process 400 for creating and displaying high quality stereo image pairs at video rate according to an embodiment of the invention. First, L, C, and R images are captured by a set of three cameras, e.g., as shown in FIG. 1 (step 405). Lens distortion in the three images is corrected (step 410) using the calibrated lens distortion parameters 415. Next, the L-to-C and R-to-C homographies determined using process 300 (step 420), are applied to the undistorted L and R images to bring those images into alignment with the undistorted C image (step 425). Optionally, contrast enhancement can be applied on the aligned L, C, and R images (step 430).

A left and right image pair (e.g., L-C, C-R, or L-R) is selected for 3-D display (step 435) to create an anaglyph (step 440). The anaglyph can, optionally, be shown on a 3-D display (step 445). Or, also optionally, an anaglyph red, green, and blue image can be created for display by loading the left image to the red channel and the right image to the green and blue channels of a display (step 450), thereby showing the anaglyph on a standard video display (step 455). In implementations providing live stereo or anaglyph images, the undistortion and alignment steps are combined into a single processing step to create the stereo image pairs at the rate with which the cameras capture the images (e.g., video rate or 30 fps).

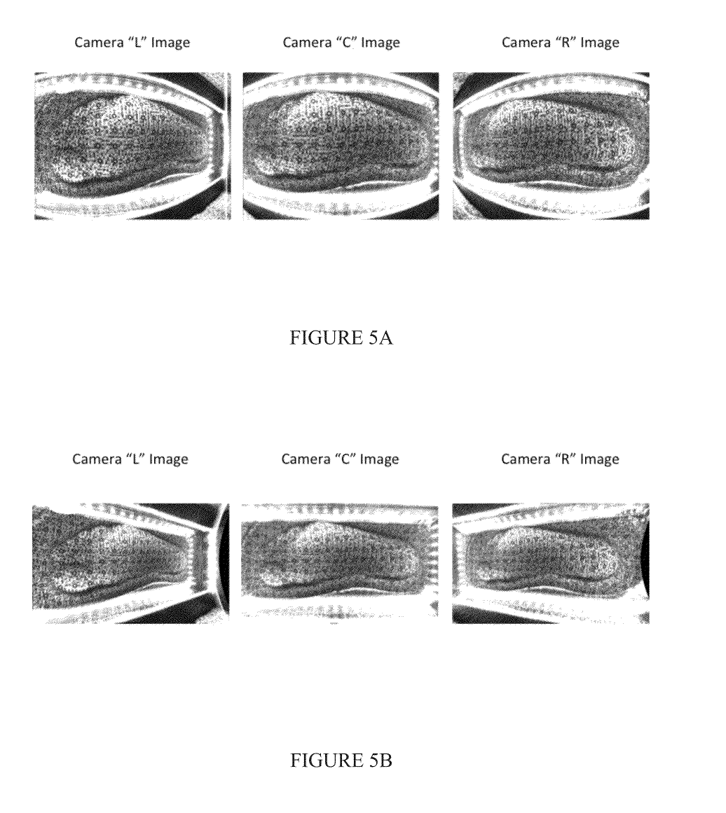

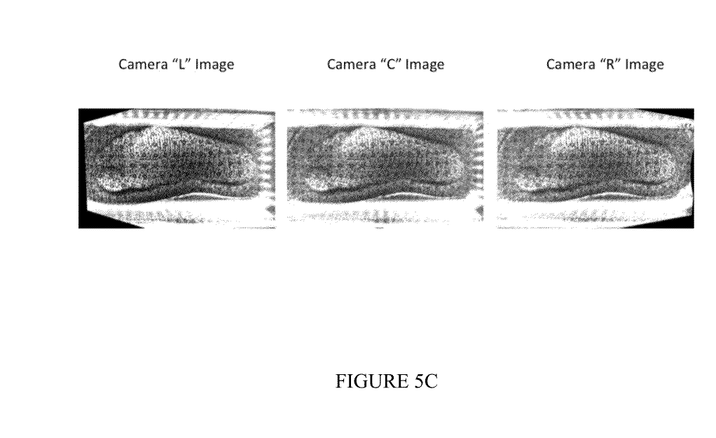

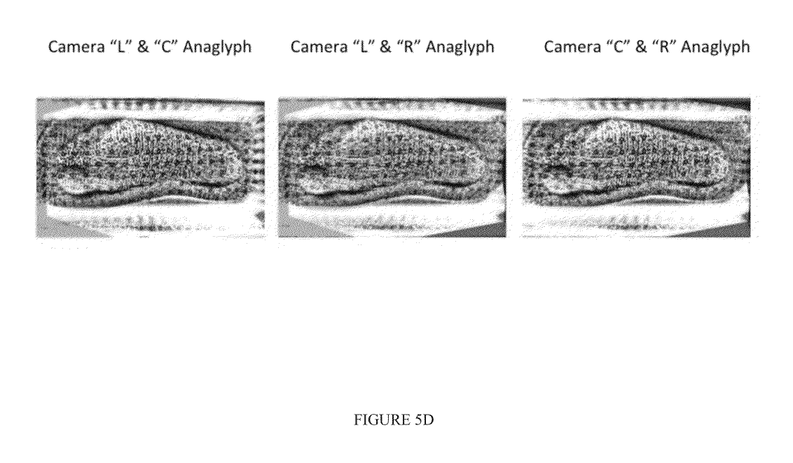

FIGS. 5A-5D show images of different steps of a preprocessing process to create high quality stereo image pairs to be visualized as anaglyph images according to an embodiment of the invention. FIG. 5A shows the original distorted images of a human foot pressed into a clear elastomer with a textured elastic fabric captured by a three-camera setup similar to that shown in FIG. 1. L, C, and R cameras capture the instantaneous impression of the foot. The images illustrate the effect of strong barrel-type lens distortion. The side, L and R, cameras are tilted towards the C camera that results in a strong keystone in the side images. Somewhat diffuse illumination is provided from the edge of the glass plate. FIG. 5B shows the images of FIG. 5A after an undistortion process removed the barrel-type lens distortion from the original images.

FIG. 5C shows the three images of FIG. 5A after undistortion and alignment processes have been applied. Applying previously recovered homographies on the undistorted images aligns the L and R images on the C image. Pairs of the aligned images can be sent directly to a 3-D display or combined into an anaglyph image to be shown on a standard display. FIG. 5D shows the three undistorted and aligned images as red-cyan anaglyph images of the foot pressed into the clear elastomer with a textured elastic fabric on it. Pairs of the images shown in FIG. 5C were combined into red, green, and blue anaglyph images to visualize the 3-D static or dynamic shape of the impression by the measured foot. Such anaglyph images can be viewed on a standard display with the help of red/cyan anaglyph glasses.

Referring again to FIG. 1, the thickness of the elastomer 115 changes locally when a 3-D object 110 (e.g., a foot) is pressed against the elastomer 115. This results in distortion artifacts in the images that can show up in the 3-D surface coordinates (X, Y, and Z) of the measured object. Under certain embodiments, spatially varying dX, dY, and dZ correction terms can be computed to correct such distortion by measuring the shape of a calibration object or objects in a known coordinate system, and computing the required correction in X, Y, and Z after aligning the measured and the known shapes.

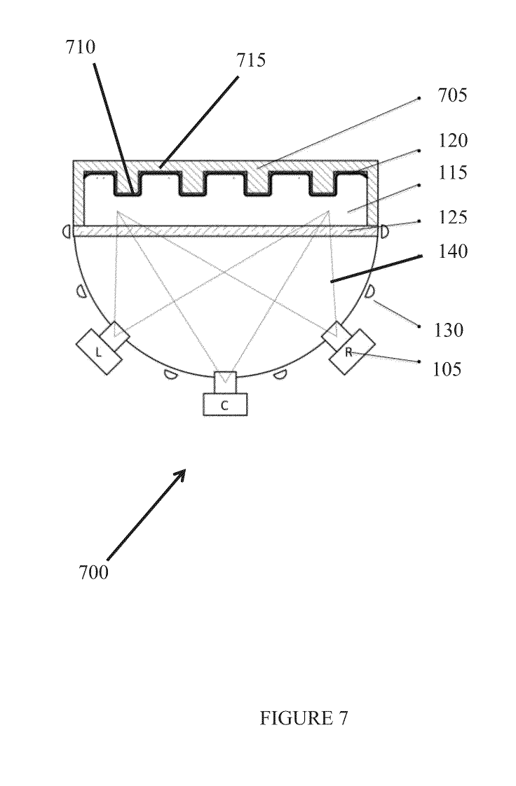

FIG. 7 shows a setup 700 to estimate the amount of required correction of distortion artifacts due to varying elastomer thickness according to an embodiment of the invention. For example, compression of the elastomer can introduce local magnification changes that cause distortions. Setup 700 includes an elastomer, having an optional reflective surface, a glass plate, cameras, and illumination sources similar to those found in FIG. 1 and described above. Setup 700 also has a ridge target 705 having ridges 710 with the same height and gaps 715 between them, or having multiple ridges with different heights, that is placed on top of the elastomer. This ridge target 705, with known dimensions and with flat planar surfaces is used to push the ridges against the elastomer such that when the ridges are impressed into the elastomer, the frame is in contact with the glass plate holding the elastomer. This ensures that the surfaces of the ridges in contact with the elastomer are in a plane with known position relative to the surface of the reference glass plate. Although FIG. 7 shows the ridge target 705 having ridges 710 of equal height and a regularly occurring pattern, certain implementations replace rigid frame 705 with other objects of know surface topography and shape such as a sphere, cylinder, or, in the case of measuring a foot, a known 3-D model of a foot.

Since the dimension of the ridge target 705 are known, so are the coordinates of points on the ridge surfaces 710 and gaps 715. The required correction parameters are computed as the difference between the measured and known coordinates of these points. In one embodiment, the reference plane parameters for the plane in which the gaps 715 lie are determined as a known distance from the top surface of the glass plate as shown in FIG. 7. The location of the top surface of the glass plate in the coordinate system of the cameras can be calibrated by placing a backlit checkerboard target on top of the glass plate and taking a plurality of images of the checkerboard target by the stationary camera rig. Once the location of this plane connecting the ridge surfaces is known, corrections (dX, dY, dZ) for the measured X, Y, and Z coordinates of points on the surfaces of the ridges are estimated.

Because the geometry of the ridge target 705 is known relative to the reference surface, one can measure how much the X, Y, and Z coordinates need to be shifted (corrected) to bring the measurement into alignment with the known geometry (again, relative to the reference surface). The procedure is repeated with different ridge heights to enable determining the required corrections as a function of image location (x, y), and image disparity (dx, dy) or measured depth (Z_{Meas}). In certain embodiments, it is sufficient to estimate the dZ(x, y, dx, dy) or dZ(x, y, Z_{Meas}) correction as the (x, y) coordinates of an image point together with the corrected depth (Z+dZ) are sufficient to compute the corresponding corrected X and Y coordinates.

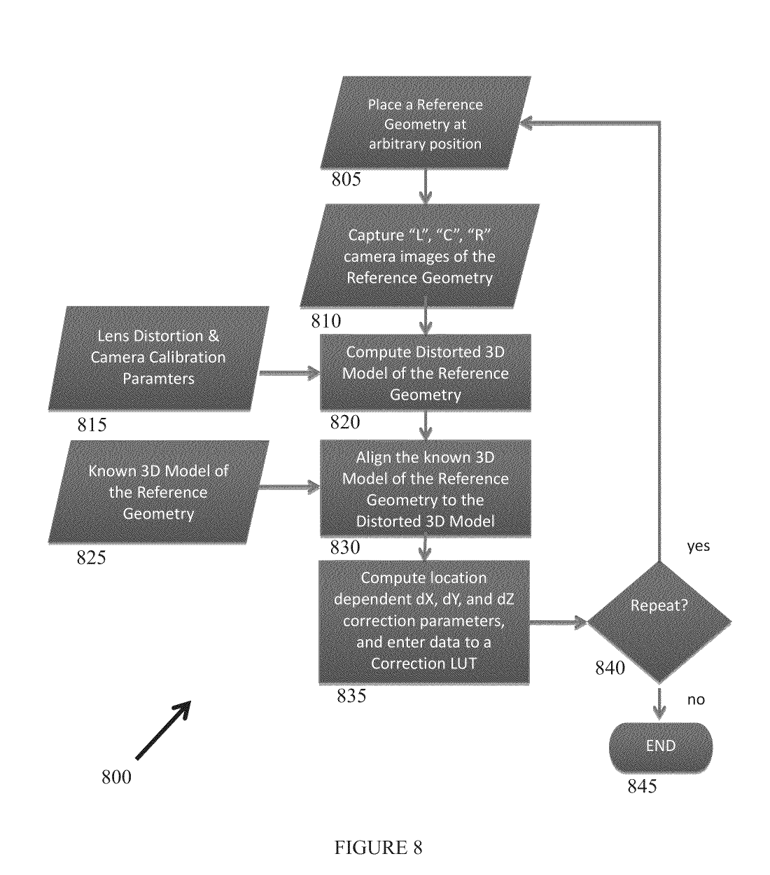

FIG. 8 shows a flowchart of a process 800 for estimating calibration correction parameters according to an embodiment of the invention. Process 800 will be described with reference to setup 700 of FIG. 7. However, process 800 is not limited to use on setup 700 alone. First, a reference geometry (such as the ridge target or other object described above, e.g., a foot model) is pressed into the elastomer 115 at an arbitrary position relative to the cameras 105 (step 805). The reference geometry is imaged to create L, C, and R images (step 810). Given the lens distortion and camera calibration parameters 815, the distorted 3-D model of the reference geometry is computed (step 820). The known 3-D model of the reference geometry 825 is then aligned to the recovered and distorted 3-D model in the coordinate system of the camera system (step 830). This alignment may be done based on specific features of the reference geometry, such as the background plane of the ridge target on FIG. 7 (gaps 715) that is at a known distance from the distal surface of the glass plate. The alignment of the reference geometry to the measured and distorted 3-D model establishes correspondences between points on the known reference geometry and the measured and distorted surface. These 3-D point correspondences allow the computation of image location dependent correction parameters (step 835). These correction parameters are then stored for later use in, e.g., a look-up table (LUT). Such LUT provides mapping from the distorted 3-D measurement space to the undistorted 3-D model space. Other storage methods are within the scope of the invention.

After the correction parameters for the distortions introduced by the reference geometry are computed and stored, a decision is made as to whether to repeat the process (step 840) in order to provide dense sampling of the space of the correction parameters. If no further correction parameters are desired, the process 800 terminates (step 845). If further correction parameters are desired, then a different reference geometry can be used and the process repeated. A different reference geometry will introduce different distortion at different positions within the elastomer, thereby providing further correction parameters. Likewise, one may use the same reference geometry placed at a different arbitrary position relative to the cameras and pressed into the elastomer. Doing so would also introduce different distortions that the previous arbitrary position.

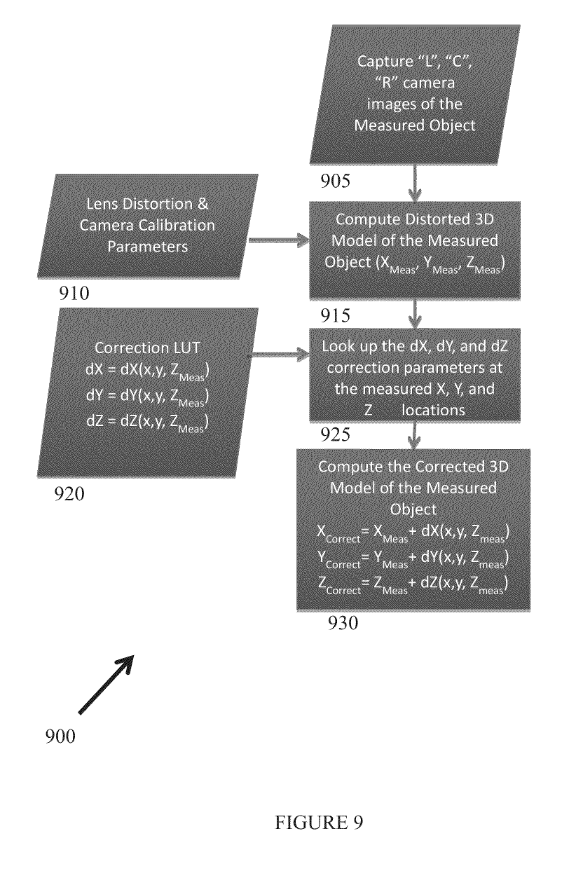

FIG. 9 shows a flowchart of a process 900 for applying distortion correction parameters to images according to an embodiment of the invention. Process 900 will be described with reference to setup 100 of FIG. 1. However, process 900 is not limited to use on setup 100 alone. First, the measured object (e.g., object 110) is imaged to create L, C, and R images with cameras 105 (step 905). The lens distortion and camera calibration parameters 910 are provided and a 3-D model of the measured object, including any distortions introduced by the elastomer, is computed (step 915). Using the corrections stored in a LUT (or other storage method), the appropriate dX, dY, and/or dZ correction parameters are retrieved based on the image space x, y, locations and the measured depth (Z_{Meas}) of the computed features of the measured object (step 925). Based on the computed 3-D model and appropriate correction parameters, a corrected 3-D model is computed by applying the correction parameters to the measured shape, topographic, and/or physical feature values.

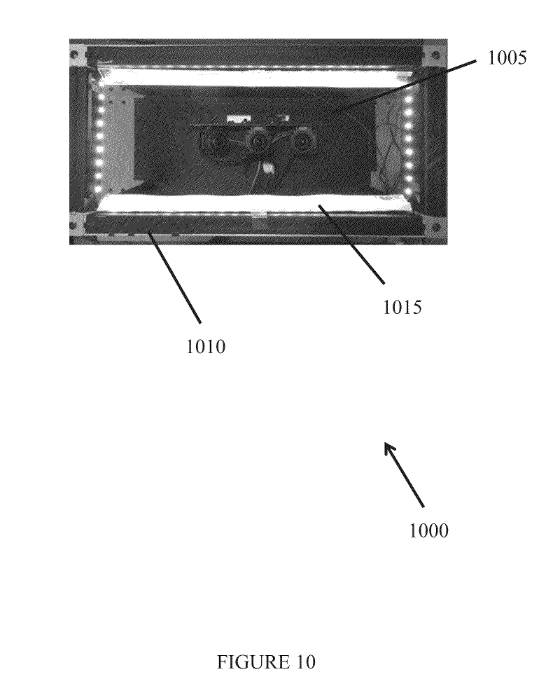

FIG. 10 shows a top view of a three-camera system 1000 according to an embodiment of the invention. Three cameras 1005 are aligned horizontally under a glass plate atop a rigid frame 1010 to capture synchronized images of instantaneous impressions of an object pressed into a clear elastomer (not shown). Illumination is provided by a set of LED stripes 1015 modified to provide partially diffuse illumination.

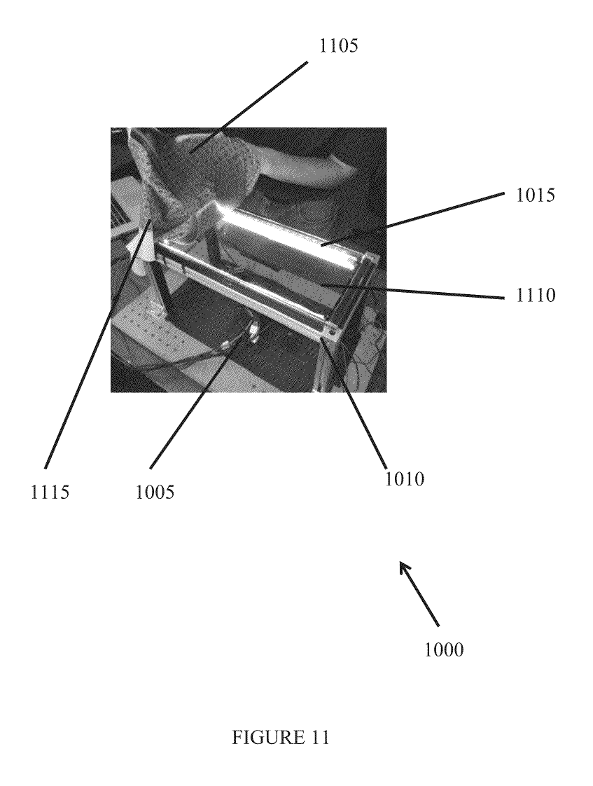

FIG. 11 shows a perspective view of the three-camera system 1000 of FIG. 10 to which is applied a clear elastomer 1105 on top of a glass plate 1110 according to an embodiment of the invention. FIG. 11 also shows the three cameras 1005 at the bottom of the rigid frame 1010 with illumination 1015. Also shown is an optional patterned fabric 1115 disposed on top of the elastomer 1105.

Certain aspects of the elastomer, optional reflective surface or membrane, light sources, fabric, and surface features of the elastomer disclosed in U.S. Pat. No. 8,411,140 can be used in conjunction with the embodiments disclosed herein. For example, in embodiments using an optional reflective membrane, the elastomer membrane can be made by adding reflective particles to the elastomer when it is in a liquid state, via solvent or heat, or before curing. This makes a reflective paint that can be attached to the surface by standard coating techniques such as spraying or dipping. The membrane may be coated directly on the surface of the bulk elastomer, or it may be first painted on a smooth medium such as glass and then transferred to the surface of the bulk material and bound there. Also, the particles (without binder) can be rubbed into the surface of the bulk elastomer, and then bound to the elastomer by heat or with a thin coat of material overlaid on the surface. Also, it may be possible to evaporate, precipitate, sputter, other otherwise attach thin films to the surface.

As described above, a reflective membrane on the surface of the elastomer is optional. Thus, the imaging of objects through a clear elastomer, with no reflective membrane is within the scope of the invention. In such an embodiment, the system 100 of FIG. 1 can be used without the optional reflective surface 120. Such a system provides benefits when imaging deformable objects, especially those having surface texture and/or favorable reflectance characteristics. However, the use of the system is not limited to deformable objects. In addition, the system can be used to image objects that have a covering that provides a desired texture, pattern, and/or particular optical characteristics (such as a known reflectance). Optionally, the covering can encode spatial location, as described in more detail above. For example, a sock with or without a pattern or texture, can be placed on a foot to be imaged.

As with the other systems set forth herein, the system without a reflective membrane can be used in conjunction with the various calibration, alignment, and correction processes set forth herein. Likewise, the system without a reflective membrane can provide images for use in stereo reconstruction and/or 3-D model estimation.

Furthermore, the embodiments herein need not rely only on reflection of light from the illumination sources as the image source for the one or more cameras of the system. A fluorescent pigment can be used in the surface of the elastomer in contact with the object to be imaged and that surface illuminated by Ultraviolet (UV) light or blacklight. If the blacklight comes at a grazing angle, it can readily reveal variations in surface normal. The material can be fairly close to Lambertian. To reduce interreflections, one would select a surface that appears dark to emitted wavelengths. This principle is true with ordinary light as well. In certain embodiments, if one is using a Lambertian pigment in the membrane, it is better for it to be gray than white, to reduce interreflections.

Blacklight or UV can be used to illuminate the resulting fluorescent surface, which would then serve as a diffuse source. In some cases, it would be useful to use a single short flash (for instance, recording the instantaneous deformation of an object against the surface) or multiple periodic (strobed) flashes (to capture rapid periodic events or to modulate one frequency down to another frequency.)

The techniques and systems disclosed herein may be implemented as a computer program product for use with a computer system or computerized electronic device. Such implementations may include a series of computer instructions, or logic, fixed either on a tangible/non-transitory medium, such as a computer readable medium (e.g., a diskette, CD-ROM, ROM, flash memory or other memory or fixed disk) or transmittable to a computer system or a device, via a modem or other interface device, such as a communications adapter connected to a network over a medium.

The medium may be either a tangible medium (e.g., optical or analog communications lines) or a medium implemented with wireless techniques (e.g., Wi-Fi, cellular, microwave, infrared or other transmission techniques). The series of computer instructions embodies at least part of the functionality described herein with respect to the system. Those skilled in the art should appreciate that such computer instructions can be written in a number of programming languages for use with many computer architectures or operating systems.

Furthermore, such instructions may be stored in any tangible memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Thus, it will be appreciated that the scope of the present invention is not limited to the above described embodiments, but rather is defined by the appended claims; and that these claims will encompass modifications of and improvements to what has been described.

What is claimed is:

1. A method of estimating optical correction parameters for an imaging system, the method comprising:
providing an optical sensor system having an image capturing system, an illumination source, and a substantially optically clear elastomer, wherein:
the elastomer has a first surface facing the image capturing system and a second surface facing away from the image capturing system, and
the image capturing system has a plurality of views of the second surface through the elastomer;
pressing an object of known surface topography against the second surface of the elastomer so that features of the surface topography are disposed relative to the second surface of the elastomer by predetermined distances;
imaging a plurality of views of the surface topography of the object through the elastomer with the image capturing system;
estimating a three-dimensional model of at least a portion of the object based on the plurality of views of the surface topography of the object; and
estimating optical correction parameters based on the known surface topography of the object and the estimated three-dimensional model, wherein the optical correction parameters correct distortions in the estimated three-dimensional model to better match the estimated three-dimensional model to the known surface topography.

2. The method of claim 1, wherein estimating the optical correction parameters includes mapping distorted measurements of three-dimensional features estimated from the plurality of views to known measurements of three-dimensional features from the known surface topography.

3. The method of claim 1, further comprising establishing a reference feature using a target image positioned a known distance from the image capturing system and using the reference feature to determine the predetermined distances.

4. The method of claim 1, wherein the image capturing system includes a plurality of cameras.

5. The method of claim 1, wherein the image capturing system includes a single camera and a lens system capable of forming a set of images from different perspectives.

6. The method of claim 1, wherein the optical sensor system includes a substantially rigid clear plate disposed between the elastomer and image capturing system.

7. The method of claim 6, wherein the rigid clear plate is constructed of at least one of glass or plastic.

8. The method of claim 7, wherein the rigid clear plate is edge-lit by the illumination source.

9. The method of claim 8, wherein the rigid clear plate includes light extraction features.

10. The method of claim 6, the optical sensor system further comprising a clear material disposed between the rigid clear plate and the image capturing system, wherein the clear material has a refractive index matched to a refractive index of the rigid clear plate.

11. A method of visualizing at least one of a surface shape and a surface topography of an object, the method comprising:
providing an optical sensor system having an image capturing system, an illumination source, and a substantially optically clear elastomer, wherein:
the elastomer has a first surface facing the image capturing system and a second surface facing away from the image capturing system, and
the image capturing system has a plurality of views of the second surface through the elastomer;
providing an alignment object on the second surface of the elastomer, wherein the alignment object has surface features;
imaging a plurality of views of the surface features of the alignment object through the elastomer with the image capturing system;
estimating a set of transform parameters that align the images of the plurality of views;
pressing an object to be visualized into the second surface of the elastomer;
imaging a plurality of views of at least one of a surface shape and a surface topography of the object to be visualized through the elastomer with the image capturing system;
applying the estimated set of transform parameters to the images of the plurality of views to create a plurality of transformed images; and
displaying at least two of the transformed images as a stereo image pair.

12. The method of claim 11, wherein a surface of the alignment object on the second surface of the elastomer is substantially planar when in contact with the second surface and includes an alignment image.

13. The method of claim 12, wherein spatial locations are encoded in the alignment image.

14. The method of claim 12, wherein the alignment image is a repeating pattern.

15. The method of claim 11, wherein the alignment object has a known topography and the alignment object is pressed into the second surface of the elastomer.

16. The method of claim 11, wherein the alignment object is included in the elastomer.

17. The method of claim 16, wherein the alignment object is an image embedded in the second surface of the elastomer.

18. The method of claim 11, wherein estimating the set of transform parameters includes:
designating one of the images of the plurality of views as a reference image,
finding a region in one of the other images of the plurality of views that corresponds with a region in the reference image, and
applying an image transformation on the region in the other image to align said region with the corresponding region in the reference image.

19. The method of claim 11, wherein the stereo image pair is an anaglyph image.

20. The method of claim 11, wherein the stereo image pair is displayed on a 3-dimensional display device.

21. The method of claim 11, wherein the stereo image pair is displayed on a standard video display by viewing a left transformed image of the stereo image pair on a red channel of the video display and a right transformed image of the stereo image pair on a green and a blue channel of the video display.

22. A method of imaging at least one of a surface shape and a surface topography of an object, the method comprising:
providing an optical sensor system having an image capturing system, an illumination source, and a substantially optically clear elastomer, wherein:
the elastomer has a first clear surface facing the image capturing system and a second clear surface facing away from the image capturing system, and
the image capturing system has a plurality of views of the second surface through the elastomer;
pressing the object to be visualized into the second surface of the elastomer;
illuminating at least a portion of the object through the second surface of the elastomer; and
imaging at least one of the plurality of views of the surface features of the object through the elastomer with the image capturing system.

23. The method of claim 22, further comprising displaying a stereo image pair based on at least two images from the plurality of views.

24. The method of claim 22, further comprising reconstructing a stereo image based on at least two images from the plurality of views and displaying the stereo image.

25. The method of claim 22, further comprising constructing a 3-dimensional model based on at least two images from the plurality of views.

26. The method of claim 22, wherein the illuminating at least a portion of the object includes illuminating the object from different directions, the imaging including imaging a plurality of images via one of the plurality of views, each image corresponding to a different illumination direction, and the method further comprising constructing a 3-dimensional model based on the plurality of images.

27. The method of claim 22, further comprising providing a covering on a least part of the object.

28. The method of claim 27, wherein the covering has a textured layer.

29. The method of claim 27, wherein the covering has a known reflectance.
